(19) United States
(12) Patent Application Publication
(10) Pub. No.: US 2019/0383473 A1
(43) Pub. Date: Dec. 19, 2019

(54) CONNECTOR AND SYSTEM

(71) Applicant: Molex, LLC, Lisle, IL (US)

(72) Inventors: James V. AGRO, Lisle, IL (US); Victor ZADEREJ, Wheaton, IL (US)

(73) Assignee: Molex, LLC, Lisle, IL (US)

(21) Appl. No.: 16/479,217

(22) PCT Filed: Jan. 17, 2018
(86) PCT No.: PCT/US2018/014065

§ 371 Date: Jul. 19, 2019

Related U.S. Application Data
(60) Provisional application No. 62/448,803, filed on Jan. 20, 2017.

(51) Int. Cl. F21V 21/096; F21V 21/34; F21S 2/00; F21S 8/06; F21V 23/06; F21V 19/00; F21V 33/00

(52) U.S. Cl. CPC F21V 21/096; F21V 21/34; F21S 2/005; F21S 8/06; F21Y 2103/10; F21V 19/003; F21V 33/0012; F21V 2200/20; F21V 23/06

(57) ABSTRACT

Various systems and apparatuses are provided to address the need for improved lighting installation. For example, systems (20, 1020) are depicted for mounting lights (22) thereon. Such systems (20, 1020) include at least one connector (24, 1024) and at least one pair of rails (26, 28, 1026, 1028), unless end feed, then only a single rail may be included. The lights (22) are mounted on the rails (26, 28, 1026, 1028) in a known manner and the connector (24, 1024) attaches the rails (26, 28, 1026, 1028) together.

### RELATED APPLICATIONS

This application claims priority to PCT Application PCT/US2018/014065, filed Jan. 17, 2018, which further claims priority to U.S. Provisional Application 62/448,803, filed Jan. 20, 2017, which are incorporated herein by reference in their entirety.

### TECHNICAL FIELD

This disclosure relates to the field of connectors, and more specifically to lighting systems.

### DESCRIPTION OF RELATED ART

Current under cabinet lighting systems and suspended lighting systems have many parts and can be difficult to assemble.

There is a need for an improved connector and system which allows a user to easily install under cabinet or suspended lighting.

### SUMMARY

The depicted embodiment is directed to a connector and rail system which enables a user to easily and quickly assemble the under-cabinet lighting or suspended lighting.

### BRIEF DESCRIPTION OF THE DRAWINGS

The present invention is illustrated by way of example and not limited in the accompanying figures in which like reference numerals indicate similar elements and in which:

FIG. 1 illustrates a perspective view of an embodiment of a system for mounting lights.

FIG. 2 illustrates a perspective view of an embodiment of a connector.

FIG. 3A illustrates a top perspective view of an embodiment of a light.

FIG. 3B illustrates a bottom perspective view of an embodiment of a light.

FIG. 4A illustrates a top perspective view of another embodiment of a light.

FIG. 4B illustrates a bottom perspective view of another embodiment of a light.

FIG. 5 illustrates a perspective view of an embodiment of two rails.

FIG. 6 illustrates a top view of an embodiment of a rail.

FIG. 7 illustrates an end view of an embodiment of a rail.

FIG. 8 illustrates a side view of an embodiment of a connector.

FIG. 9 illustrates an exploded perspective view of an embodiment of a top portion of a connector.

FIG. 10 illustrates an exploded perspective view of an embodiment of a bottom portion of a connector.

FIG. 11 illustrates an enlarged perspective view of an embodiment of a connector with a top cover removed.

FIG. 12 illustrates a perspective view of an embodiment of a contact plate assembly.

FIG. 13 illustrates an exploded perspective view of an embodiment of a contact plate assembly.

FIG. 14 illustrates a top view of an embodiment of a contact plate assembly housing.

FIG. 15 illustrates a perspective view of an embodiment of an upper cover of a connector.

FIG. 16 illustrates a perspective view of an embodiment of a lower cover of a connector.

FIG. 17 illustrates a perspective view of an embodiment of one of an upper pair of frames of a connector.

FIG. 18 illustrates a perspective view of an embodiment of the other of an upper pair of frames of a connector.

FIG. 19 illustrates a perspective view of an embodiment of a right-angle connector.

FIG. 20 illustrates a perspective view of an embodiment of a three-leg connector.

FIG. 21 illustrates a perspective view of an embodiment of a four-leg connector.

FIG. 22 illustrates a perspective view of an embodiment of a capped-leg connector.

FIG. 23 illustrates an enlarged perspective view of an embodiment of a system for mounting lights.

FIG. 24 illustrates a perspective view of an embodiment of a connector.

FIG. 25 illustrates an enlarged perspective view of an embodiment of a rail.

FIG. 26 illustrates an end view of an embodiment of a rail.

FIG. 27 illustrates an exploded perspective view of an embodiment of a top portion of a connector.

FIG. 28 illustrates an exploded perspective view of an embodiment of a bottom portion of a connector.

FIG. 29 illustrates a perspective view of an embodiment of a right-angle connector.

FIG. 30 illustrates a perspective view of an embodiment of a three-leg connector.

FIG. 31 illustrates a perspective view of an embodiment of a four-leg connector.

FIG. 32 illustrates a perspective view of an embodiment of a connector with separated legs.

FIG. 33 illustrates a perspective view of an embodiment of a connector with a power button.

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

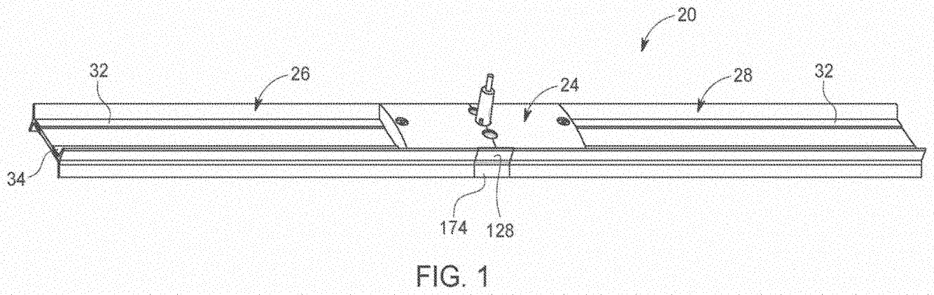

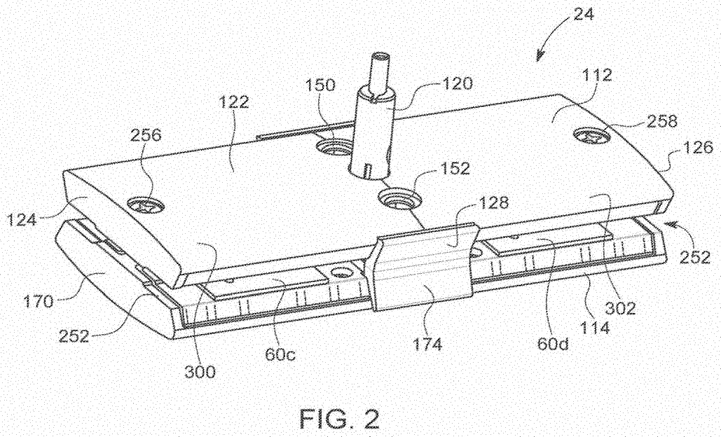

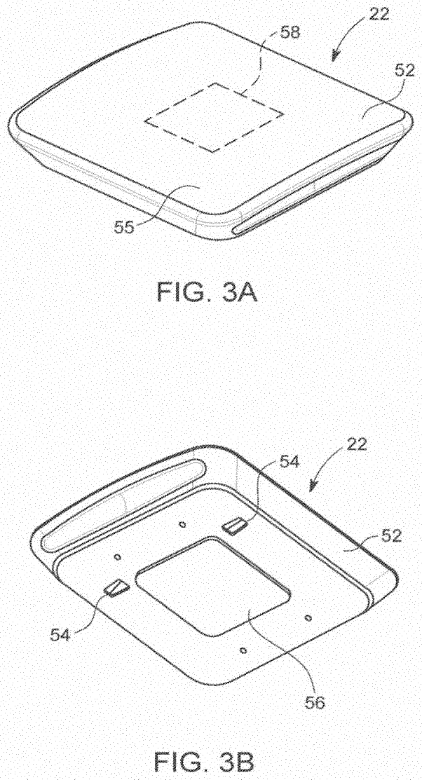

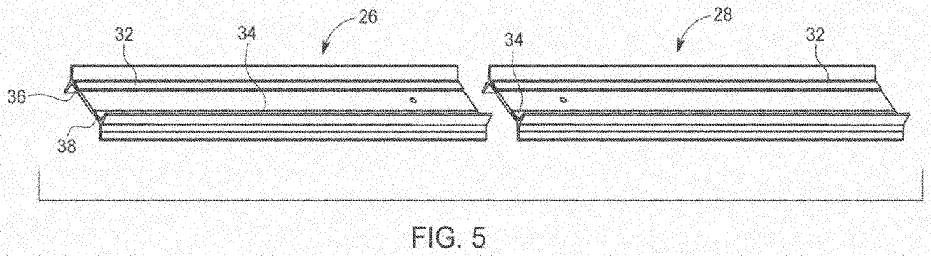

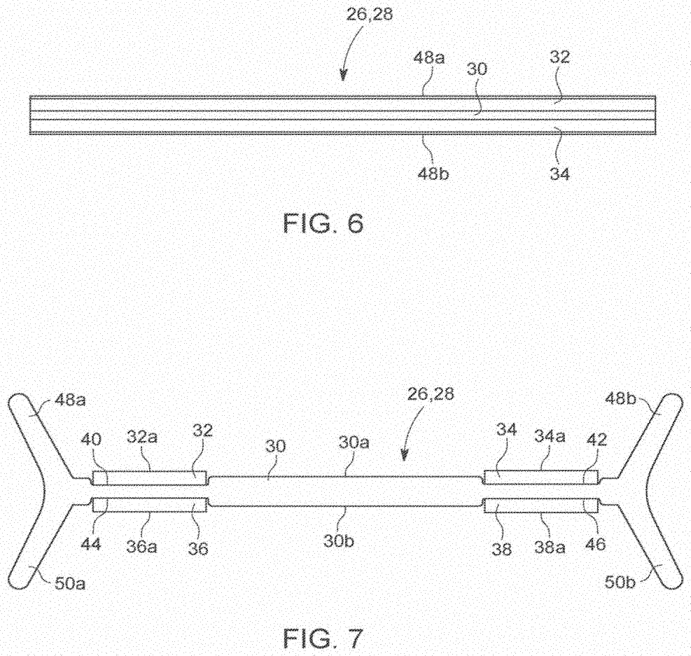

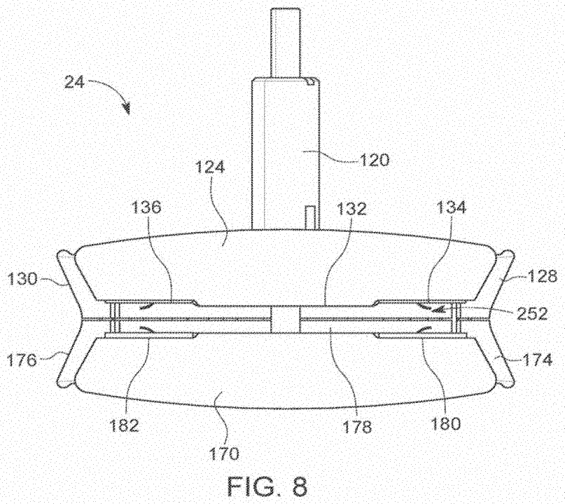

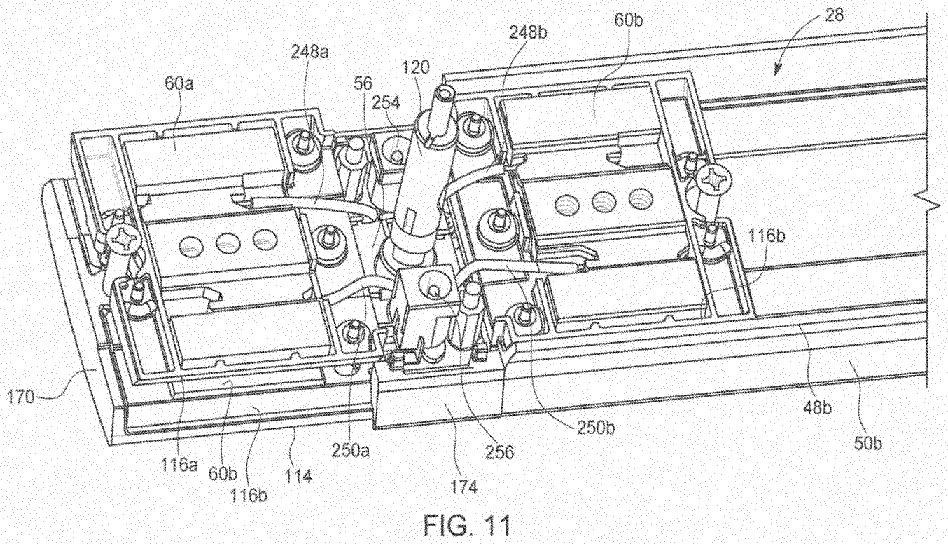

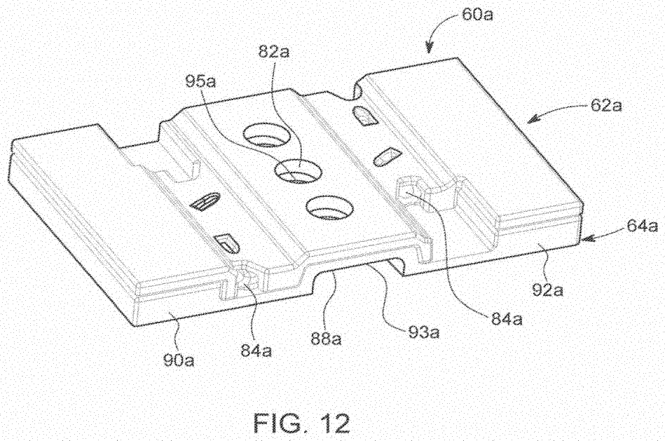

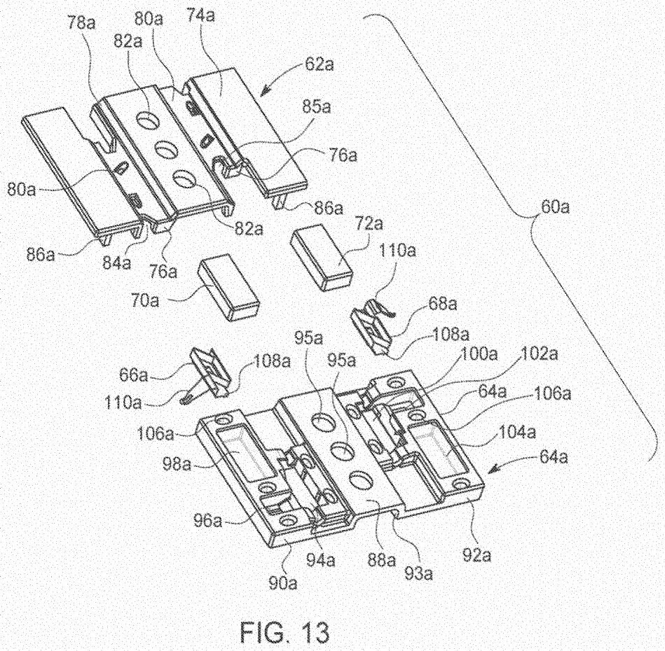

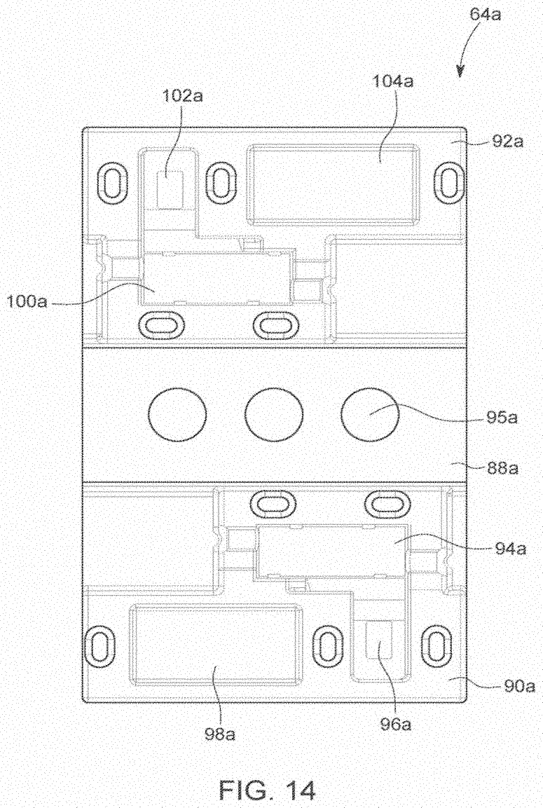

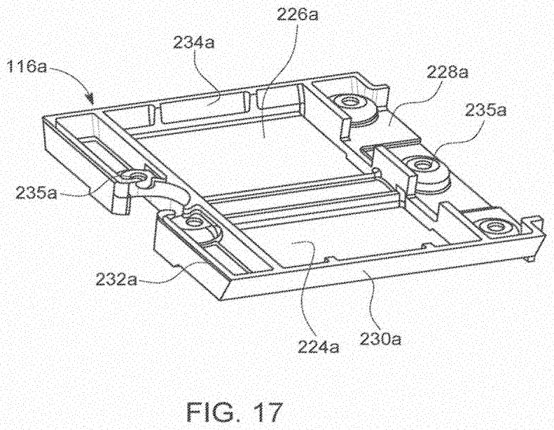

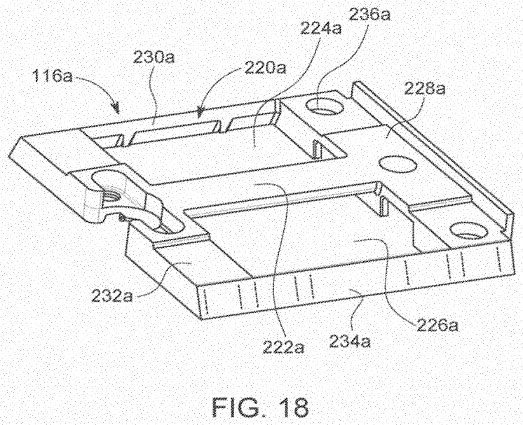

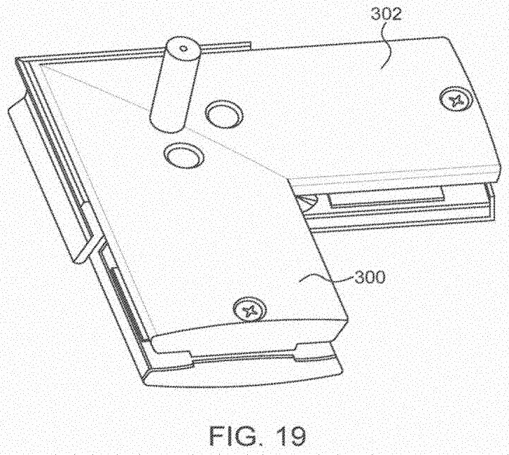

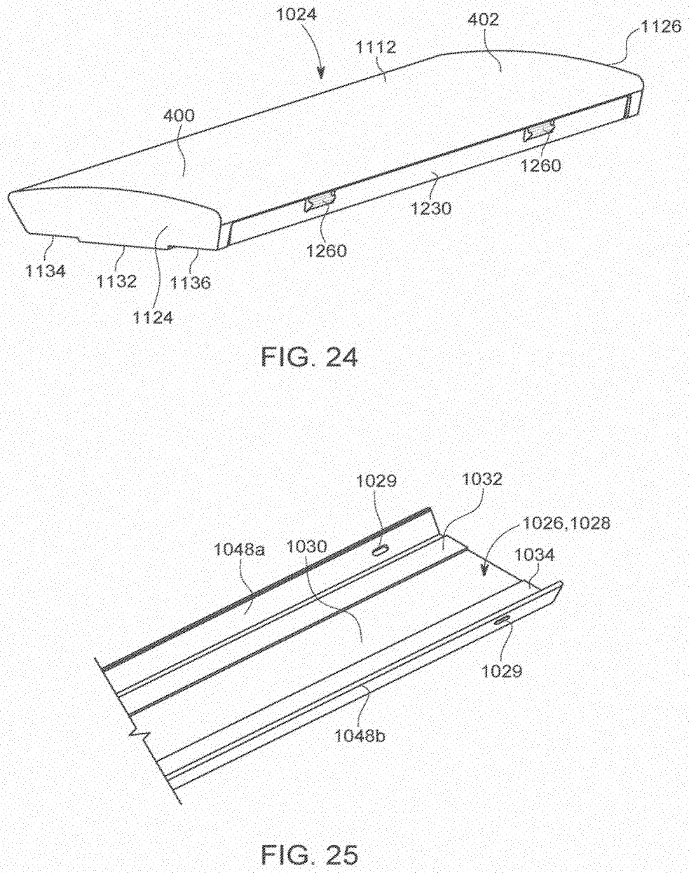

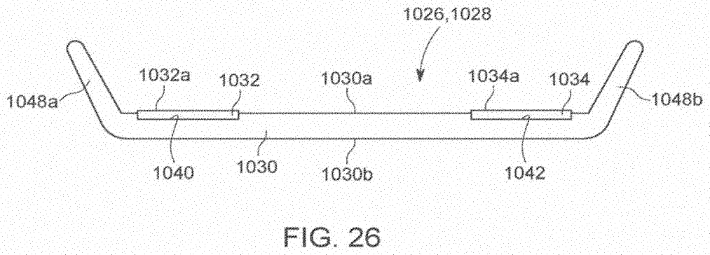

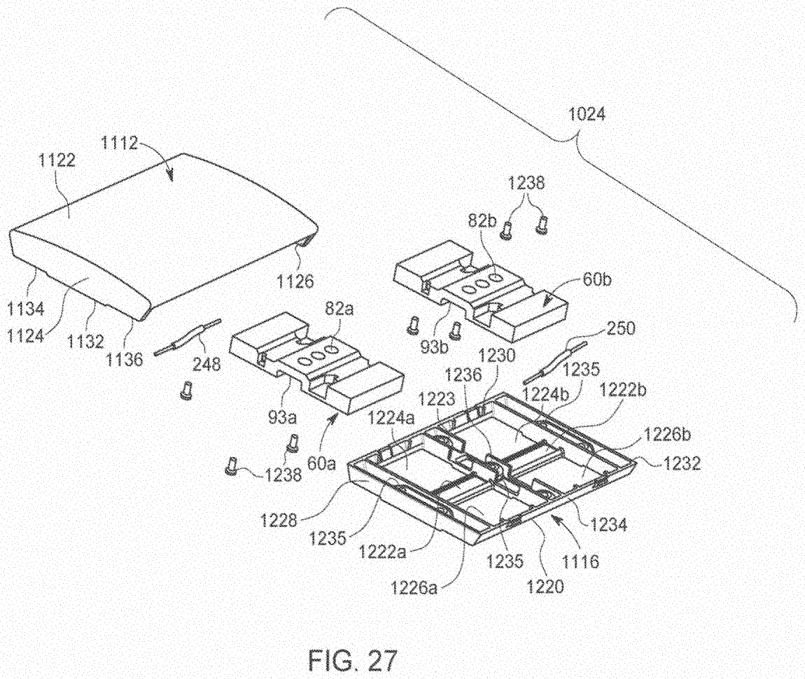

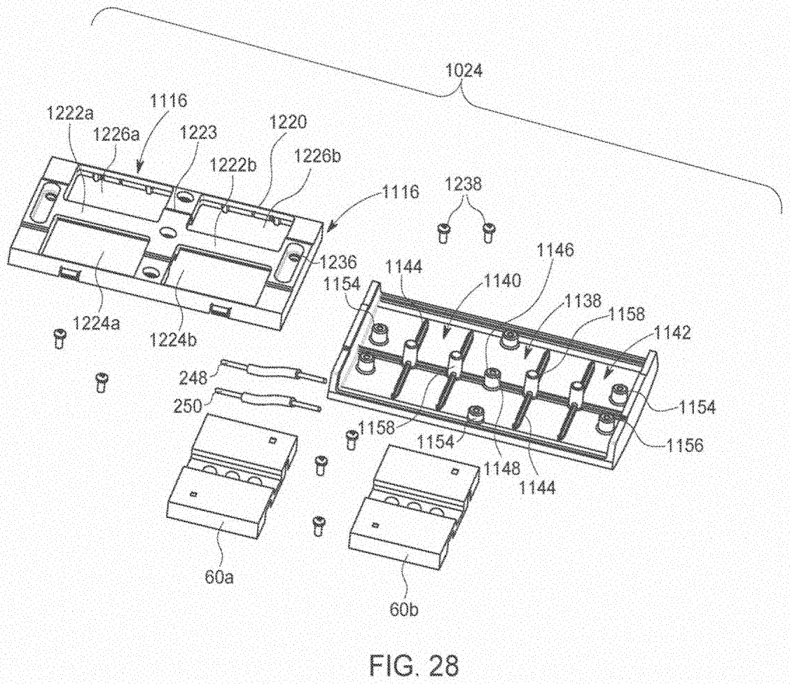

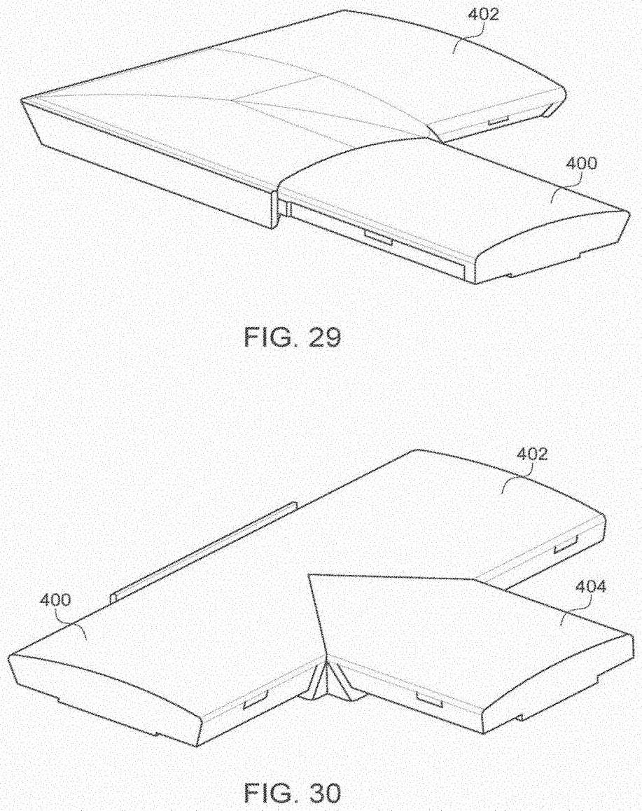

The present disclosure is directed to a system 20, 1020 for mounting lights 22 thereon. The system 20, 1020 includes at least one connector 24, 1024 and at least one pair of rails 26, 28, 1026, 1028 (unless an end feed, then a single rail). The lights 22 are mounted on the rails 26, 28, 1026, 1028 in a known manner and the connector 24, 1024 attaches the rails 26, 28, 1026, 1028 together. A first embodiment of the system 20 is shown in FIGS. 1-18; alternate embodiments to the first embodiment are shown in FIGS. 19-22; a second embodiment of the system 1020 is shown in FIGS. 3A, 3B, 4A, 4B, 12-14 and 23-28; alternate embodiments to the second embodiment are shown in FIGS. 29-33. It is to be understood that the system 20, 1020 may include multiple rails and connectors which are joined together to form the complete system. For ease in description, a single connector 24, 1024 and two associated rails 26, 28, 1026, 1028 are described.

The rails 26, 28 have a planar base wall 30 having conductive strips or bus bars 32, 34, 36, 38 mounted on the base wall 30. The rails 26, 28 are formed of a metal extrusion, and in an embodiment, may be formed of aluminum. In an embodiment, the conductive strips 32, 34, 36, 38 are formed of cold rolled steel with a nickel plate and an overplate stripe of palladium. The base wall 30 has an upper pair of spaced apart recesses 40, 42 formed in its upper surface 30a, and a lower pair of spaced apart recesses 44, 46 formed in its lower surface 30b. Each recess 40, 42, 44, 46 extends along the entire length of the base wall 30. The conductive strips 32, 34 are mounted within the upper recesses 40, 42 such that a top surface 32a, 34a of the conductive strips 32, 34 extend above the upper surface of the base wall 30. The conductive strips 36, 38 are mounted within the lower recesses 44, 46 such that a bottom surface 36a, 38a of the conductive strips 36, 38 extend below the lower surface 30b of the base wall 30. A pair of upper side walls 48a, 48b extend upwardly from each side edge of the base wall 30. A pair of lower side walls 50a, 50b extend downwardly from each side edge of the base wall 30. The side walls 48a, 48b, 50a, 50b may extend at an angle relative to the base wall 30. The rails 26, 28 may take a variety of shapes, such as being linear, as shown in FIGS. 1, 5 and 6, having offsets along its length, having a corner formed along its length, having curves along its length, etc.

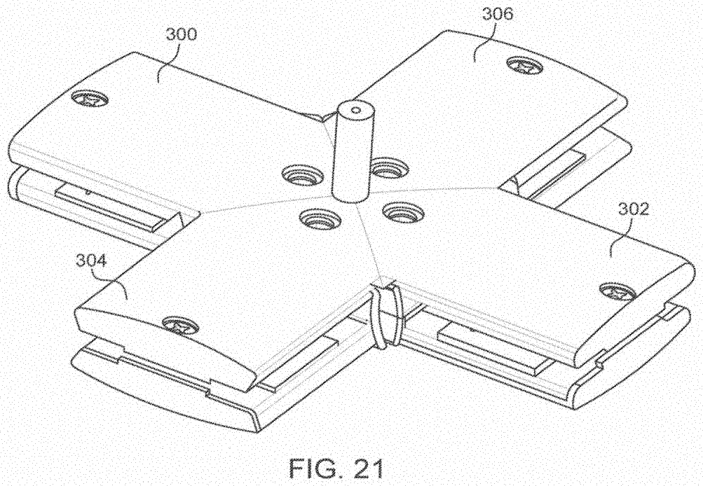

The rails 1026, 1028 have a planar base wall 1030 having conductive strips or bus bars 1032, 1034 mounted on the base wall 1030. The rails 1026, 1028 are formed of a metal extrusion, and in an embodiment, may be formed of aluminum. In an embodiment, the conductive strips 1032, 1034 are formed of cold rolled steel with a nickel plate and an overplate stripe of palladium. The base wall 1030 has an upper pair of spaced apart recesses 1040, 1042 formed in its upper surface 1030a. Each recess 1040, 1042 extends along the entire length of the base wall 1030. The conductive strips 1032, 1034 are mounted within the upper recesses 1040, 1042 such that a top surface 1032a, 1034a of the conductive strips 1032, 1034 extend above the upper surface of the base wall 1030. A pair of side walls 1048a, 1048b extend upwardly from each side edge of the base wall 1030. The side walls 1048a, 1048b may extend at an angle relative to the base wall 1030. The rails 1026, 1028 may take a variety of shapes, such as being linear, as shown in FIGS. 19 and 21, having offsets along its length, having a corner formed along its length, having curves along its length, etc. Each rail 1026, 1028 has an aperture(s) 1029 in its side wall 1048a, 1048b proximate to each end.

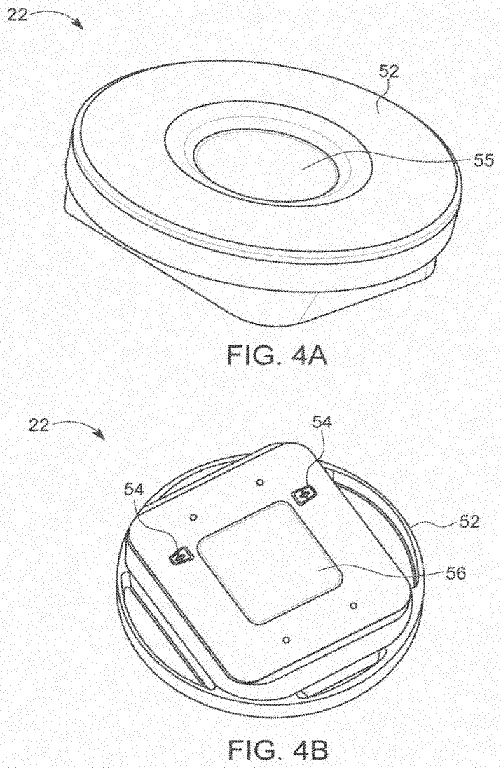

Such lights 22 are conventionally known. Examples of suitable lights 22 are shown in FIGS. 3A, 3B, 4A and 4B. The lights 22 may take the form of “pucks” and may be round, square, rectangular, etc. In general, the lights 22 include a housing 52, contacts 54 provided on a bottom of the housing 52, an electronics package 56 within (or on the bottom of) the housing 52 which are in electrical contact with the contacts 54 and which are used to illuminate the light source 55, such as an LED. Magnet(s) 58 are enclosed within the housing 52 to secure the lights 22 to the rails 26, 28, 1026, 1028. The contacts 54 mate with the conductive strips 32, 34, 36, 38, 1032, 1034 on the rails 26, 28, 1026, 1028. The magnetic attraction provided by the magnet(s) 58 and the conductive strips 32, 34, 36, 38, 1032, 1034 on the rails 26, 28, 1026, 1028 creates a load on the contacts 54. The rails 26, 28, 1026, 1028 provide a heat sink for the lights 22.

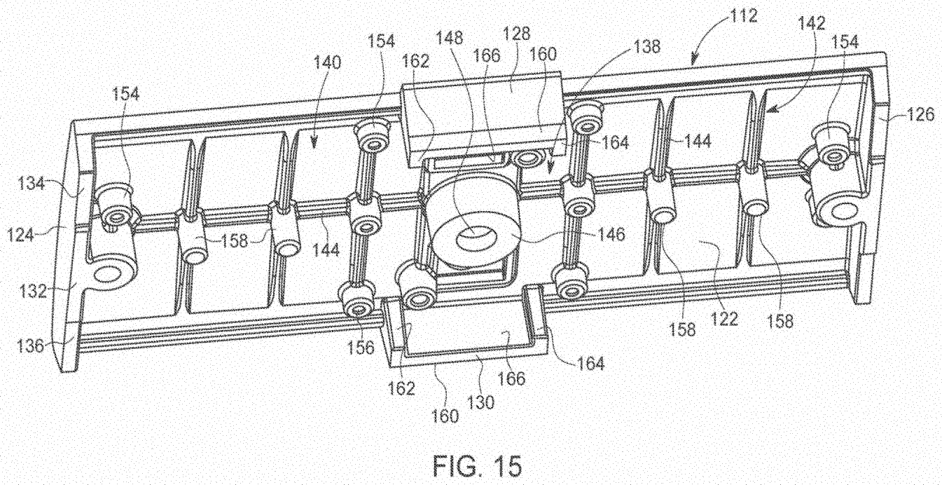

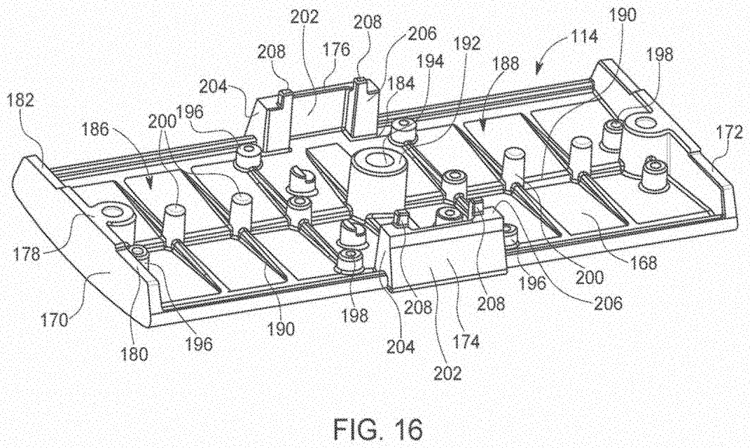

The connector 24 includes an upper cover 112, an upper pair of contact plate assemblies 60a, 60b mounted by an upper pair of frames 116a, 116b to the upper cover 112, a lower cover 114, and a lower pair of contact plate assemblies 60a, 60b mounted by a lower pair of frames 116a, 116b to the lower cover 114. As shown in FIG. 15, the lower surface of the upper cover 112 defines an electronics receiving space 138 which is centrally positioned on the lower surface of the upper cover 112, a first frame/contact plate assembly receiving space 140 between the electronics receiving space 138 and an end of the upper cover 112, and a second frame/contact plate assembly receiving space 142 between the electronics receiving space 138 and the opposite end of the upper cover. As shown in FIG. 16, the lower cover 114 defines an electronics receiving space 184 which is centrally positioned on the upper surface of the lower cover 114, a first frame/contact plate assembly receiving space 186 between the electronics receiving space 184 and an end of the lower cover 114, and a second frame/contact plate assembly receiving space 188 between the electronics receiving space 184 and opposite end of the lower cover 114. The upper cover 112 and the lower cover 114 are mated together to form the connector 24, with the frames and contact plate assemblies mounted therebetween. The electronics receiving spaces 138, 184 align with each other; the first frame/contact plate assembly receiving spaces 140, 186 align with each other; and the second frame/contact plate assembly receiving spaces 142, 188 align with each other. The alignment of the electronics receiving spaces 138, 184 form an electronics receiving area into which the electronics package 56 is mounted for connecting the contact plate assemblies 60a, 60b together. The portion of the upper cover 112 having the upper frame 116a attached thereto and the contact plate assembly 60a mounted therebetween and the portion of the lower cover 114 having the lower frame 116b attached thereto and the contact plate assembly 60b mounted therebetween forms a first leg 300 of the connector 24. The portion of the upper cover 112 having the upper frame 116b attached thereto and the contact plate assembly 60b mounted therebetween and the portion of the lower cover 114 having the lower frame 116a attached thereto and the contact plate assembly 60a mounted therebetween forms a second leg 302 of the connector 24. The electronics receiving area formed by the electronics receiving space 138 of the upper cover 112 and the electronics receiving space 184 of lower cover 114 is between the legs 300, 302.

The connector 1024 includes a cover 1112 and two contact plate assemblies 60a, 60b mounted by frame 116 to the cover 1112.

Each contact plate assembly 60a, 60b is identically formed, and thus only a single contact plate assembly 60a is described with the understanding that the contact plate assembly 60b like reference numerals, but with the suffix “b” thereafter, or being numbered in the tens or thousands.

The contact plate assembly 60a is formed from a first housing 62a and a second housing 64a which are mated together, a first conductive contact 66a mounted between the housings 62a, 64a, a second conductive contact 68a mounted between the housings 62a, 64a, and first and second magnets 70a, 72a which are mounted in the second housing 64a and between the housings 62a, 64a. The housings 62a, 64a are formed of plastic. The magnets 70a, 72a are formed of neodymium.

The first housing 62a has a base wall 74a, and side walls 76a, 78a which extend downwardly from the base wall 74a. As shown, channels 80a are provided in the base wall 74a, but these channels 80a may be eliminated such that the base wall 74a has a planar first surface. The base wall 74a has a plurality of spaced apart apertures 82a therethrough which align with a centerline of the base wall 74a. Cutouts 84a, 85a are provided through the side walls 76a, 78a to allow a conductor to pass therethrough. The cutouts 84a, 85a are offset from the centerline of the first housing 62a. A plurality of spaced apart fingers 86a extend downwardly from a second surface of the base wall 74a.

The second housing 64a has a central section 88a, a first outer section 90a extending from one side of the central section 88a, and a second outer section 92a extending from the other side of the central section 88a. The central section 88a has a channel 93a formed in its second surface which extends from a first end of the central section 88a to a second end of the central section 88a. The central section 88a has a plurality of spaced apart apertures 95a therethrough which align with a centerline of the second housing 64a, the centerline extending from the first end of the central section 88a to a second end of the central section 88a. The first outer section 90a has a first recess 94a extending from its first surface and an aperture 96a extending therethrough proximate to the first recess 94a. The contact 66a seats within the first recess 94a and the aperture 96a. The first outer section 90a further has a second recess 98a extending from its first surface and which is spaced from the first recess 94a and aperture 96a. The magnet 70a seats within the second recess 98a. The second outer section 92a has a first recess 100a extending from its first surface and an aperture 102a extending therethrough proximate to the first recess. The contact 68a seats within the first recess 100a and the aperture 102a. The second outer section 92a further has a second recess 104a extending from its first surface and which is spaced from the first recess 100a and aperture 102a. The magnet 72a seats within the second recess 104a.

A first surface of the sections 88a, 90a, 92a mates with a second surface of the first housing 62a. The apertures 82a, 95a align with each other. The second housing 64a further has a plurality of passageways 106a through which the fingers 86a on the first housing 62a extend when the first and second housings 62a, 64a are mated together. The engagement of the fingers 86a in the passageways 106a provides a secure connection of the first and second housings together 62a, 64a. The fingers 86a may be ultrasonically welded to the second housing 64a. It is to be understood that the fingers 86a could instead be provided on the second housing 64a and the passageways 106a provided on the first housing 62a.

Each contact 66a, 68a has a base portion 108a from which a spring leg 110a extends. The base portion 108a of the contact 66a seats within the recess 94a and the leg 110a of the contact 66a extends through the aperture 96a and extends from the bottom surface of the second housing 64a. The base portion 108a of the contact 68a seats within the recess 100a and the leg 110a of the contact 68a extends through the aperture 102a and extends from the bottom surface of the second housing 64a. In the first embodiment of the system 20, each contact 66a, 68a further includes a conductor 248a, 250a connected to the base portion 108a. The conductors 248a, 250a extend through the cutouts 84a, 85a in the side wall 76a for connection to the electronics package 56. In the second embodiment of the system 1020, conductors 248, 250 are provided for coupling contacts 66a, 66b and contacts 68a, 68b. The conductors 248, 250 extend through the cutouts 84a, 85a in the side wall 76a. Attention is invited to the first embodiment of the system 20 which includes the connector 24 and the rails 26, 28 shown in FIGS. 1-18. In use, the contact plate assembly 60a on the upper cover 112 faces the contact plate assembly 60b on the lower cover 114 in each leg 300, 302.

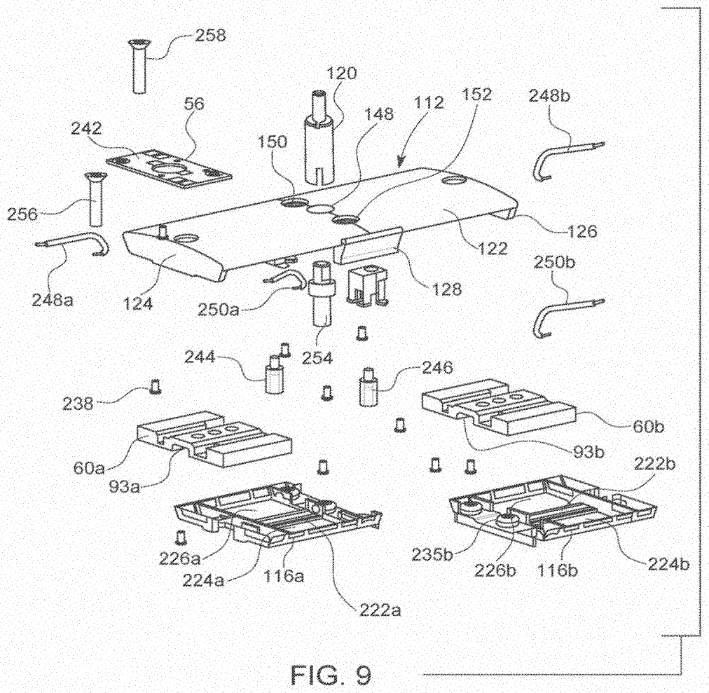

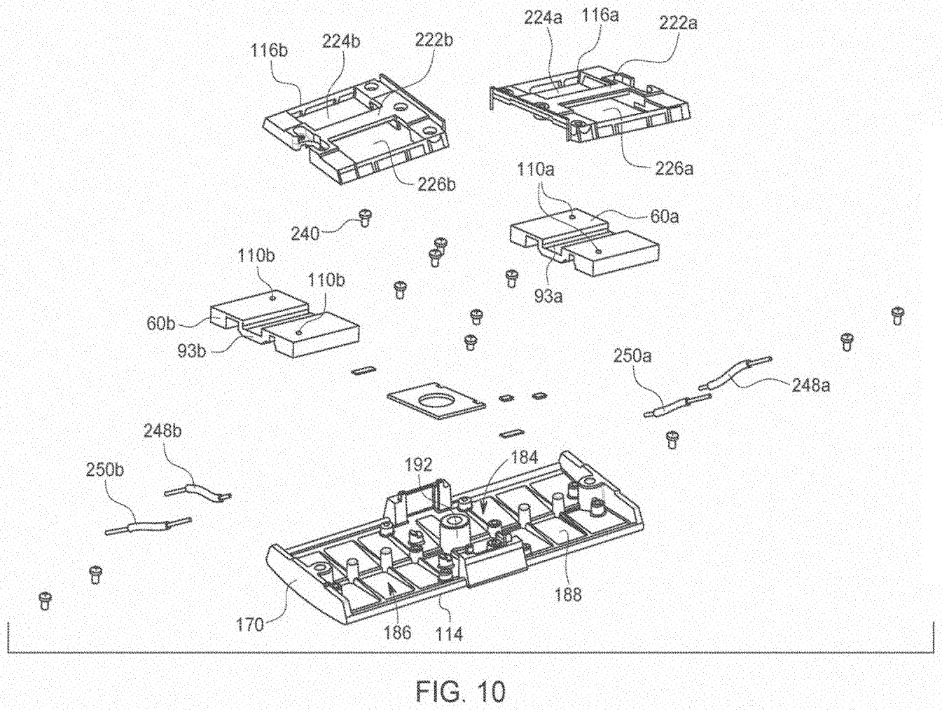

The connector 24 includes the upper cover 112, the lower cover 114 attached to the upper cover 112, the upper pair of frames 116a, 116b attached to the upper cover 112 (shown exploded in FIG. 9), the contact plate assemblies 60a, 60b mounted between the upper cover 112 and the respective upper frames 116a, 116b (shown exploded in FIG. 9), a pair of lower frames 116c, 116d attached to the lower cover 114 (shown exploded in FIG. 10), the contact plate assemblies 60c, 60d mounted between the lower cover 114 and the respective lower frames 116c, 116d (shown exploded in FIG. 10), and the electronics package 56 for powering the connector 24. A cable grip 120 may be provided to suspend the connector 24 and rails 26, 28 from a ceiling or other structure. The connector 24 slides onto the end portions of the adjacent rails 26, 28.

The upper cover 112 is formed from a base wall 122, a first end wall 124 extending downwardly from a first end of the base wall 122, a second end wall 126 extending downwardly from a second end of the base wall 122, a first side wall 128 extending downwardly from a first side edge of the base wall 122, and a second side wall 130 extending downwardly from a second side edge of the base wall 122. The base wall 122 may be curved.

The end walls 124, 126 have a lower edge which has a central portion 132 and side portions 134, 136 that extend outwardly from the central portion 132. The central portion 132 is offset downwardly from the side portions 134, 136.

As shown in FIG. 15, the lower surface of the upper cover 112 defines the electronics receiving space 138 which is centrally positioned on the lower surface and between the side walls 128, 130, the first frame/contact plate assembly receiving space 140 between the electronics receiving space 138 and the first end wall 124, and the second frame/contact plate assembly receiving space 142 between the electronics receiving space 138 and the second end wall 126. A plurality of support ribs 144 extend downwardly from the lower surface. A boss 146 extends downwardly from the lower surface of the electronics receiving space 138. The boss 146 includes a passageway 148 therethrough which also extends through the upper cover 112. A pair of apertures 150, 152 are provided through the upper cover 112 and into the electronics receiving space 138. The apertures 150, 152 are spaced from the boss 146.

A plurality of fastener receiving extensions 154 extend downwardly from the lower surface of the first and second frame/contact plate assembly receiving spaces 140, 142. Each fastener receiving extension 154 has a fastener receiving bore 156 therein. A plurality of spaced apart support fingers 158 also extend downwardly from the lower surface of the first and second frame/contact plate assembly receiving spaces 140, 142. The support fingers 158 are linearly aligned with each other and fall along the centerline of the upper cover 112.

The side walls 128, 130 extend from a midpoint of the upper cover 112 and define the electronics receiving space 138 therebetween. Each side wall 128, 130 has a central wall 160 which extends along a portion of the length of the base wall 122, a first end wall 162 extending perpendicularly from a first end of the central wall 160 and into the electronics receiving space 138, and a second end wall 164 extending perpendicularly from a second end of the central wall 160 and into the electronics receiving space 138. The walls 160, 162, 164 form a pocket 166 on each side of the upper cover 112.

The lower cover 114 is formed from a base wall 168, a first end wall 170 extending upwardly from a first end of the base wall 168, a second end wall 172 extending upwardly from a second end of the base wall 168, a first side wall 174 extending upwardly from a first side edge of the base wall 168, and a second side wall 176 extending upwardly from a second side edge of the base wall 168. The base wall 168 may be curved.

The end walls 170, 172 have an upper edge which has a central portion 178 and side portions 180, 182 that extend outwardly from the central portion 178. The central portion 178 is offset upwardly from the side portions 180, 182.

The upper surface of the lower cover 114 defines the electronics receiving space 184 which is centrally positioned on the upper surface and between the side walls 174, 176, the first frame/contact plate assembly receiving space 186 between the electronics receiving space 184 and the first end of the base wall 168, and the second frame/contact plate assembly receiving space 188 between the electronics receiving space 184 and the second end of the base wall 168. A plurality of support ribs 190 extend upwardly from the upper surface. A boss 192 extends upwardly from the upper surface of the electronics receiving space 184. The boss 192 include a bore 194 therein.

A plurality of fastener receiving extensions 196 extend upwardly from the upper surface of the first and second frame/contact plate assembly receiving spaces 186, 188. Each fastener receiving extension 196 has a fastener receiving bore 198 therein. A plurality of spaced apart support fingers 200 also extend upwardly from the upper surface of the first and second frame/contact plate assembly receiving spaces 186, 188. The support fingers 200 are linearly aligned with each other and fall along the centerline of the lower cover 114.

The side walls 174, 176 extend from a midpoint of the lower cover 114 and define the electronics receiving space 184 therebetween. Each side wall 174, 176 has a central wall 202 which extends along a portion of the length of the base wall 168, a first end wall 204 extending perpendicularly from a first end of the central wall 202 and into the electronics receiving space 184, and a second end wall 206 extending perpendicularly from a second end of the central wall 202 and into the electronics receiving space 184. A post 208 extends upwardly from the end walls 204, 206.

Each frame 116a, 116b is identically formed and thus frame 116a is described with the understanding that the other frames have like reference numerals, but with the suffix “b”. The frames 116a, 116b are formed of plastic.

The frame 116a is formed from an outer perimeter wall 220a and a central rib 222a which form a pair of cutouts 224a, 226a. The outer perimeter wall 220a is formed of a first section 228a, a second section 230a which is perpendicular to the first section 228a, a third section 232a which is perpendicular to the second section 230a and parallel to the first section 228a, and a fourth section 234a which is perpendicular to the third section 232a and parallel to the second section 230a. The sections 228a, 230a, 232a, 234a of the outer perimeter wall 220a define a plane along their first surfaces. The central rib 222a extends between the first and third sections 228a, 232a of the outer perimeter wall 220a. The central rib 222a has a height which is less than the height of the outer perimeter wall 220a.

The frame 116a has a plurality of fastener receiving extensions 235a therethrough which receive fasteners 238 in passageways 236a therethrough for attaching the frame 116a to the respective cover 112, 114. In an embodiment, the fastener receiving extensions 235a extend from the first and third sections 228a, 232a.

The second and fourth sections 230a, 234a of the outer perimeter wall 220a have outer surfaces which match the profile of the side walls 48a, 48b, 50a, 50b of the rails 26, 28. As shown, the outer surfaces of the second and fourth sections 230a, 234a are angled outwardly.

When the frame 116a is attached to the upper cover 112 in the first frame/contact plate assembly receiving space 140 of the upper cover 112, a recess is formed between the first frame/contact plate assembly receiving space 140 and the frame 116a since the central rib 222a has a height that is less than the height of the outer perimeter wall 220a. Likewise, when the frame 116b is attached to the upper cover 112 in the second frame/contact plate assembly receiving space 142 of the upper cover 112, a recess is formed between the second frame/contact plate assembly receiving space 142 and the frame 116b since the central rib 222b has a height that is less than the height of the outer perimeter wall 220b. The fastener receiving extensions 154 on the upper cover 112 align and engage with the fastener receiving extensions 235a, 235b on the frames 116a, 116b. Fasteners 238 extend into the respective aligned fastener receiving extensions 154, 235a, 235b to secure the frames 116a, 116b to the upper cover 112. When the frames 116a, 116b are attached to the upper cover 112, a lower end of each support finger 158 contacts the respective central rib 222a, 222b.

The first contact plate assembly 60a seats within the recess formed between the first frame/contact plate assembly receiving space 140 of the upper cover 112 and the frame 116a. The central rib 222a seats within the channel 93a. The fingers 158 on the upper cover 112 extend through the apertures 82a, 95a and contact the central rib 222a. The spring legs 110a of the contacts 66a, 68a extend through the cutouts 224a, 226a in the frame 116a. The second contact plate assembly 60b seats within the recess formed between the second frame/contact plate assembly receiving space 142 of the upper cover 112 and the frame 116b. The central rib 222b seats within the channel 93b. The fingers 158 on the upper cover 112 extend through the apertures 82b, 95b and contact the central rib 222b. The spring legs 110b of the contacts 66b, 68b extend through the cutouts 224b, 226b in the frame 116b. Each recess formed between the upper cover 112 and the respective contact plate assembly 60a, 60b has a height which allows the contact plate assemblies 60a, 60b to move or “float” upwardly and downwardly between the upper cover 112 and the respective frame 116a, 116b, but prevents the contact plate assemblies 60a, 60b from disengaging from engagement with the central rib 222a, 222b of the frames 116a, 116b.

When the frame 116b is attached to the lower cover 114 in the first frame/contact plate assembly receiving space 186 of the lower cover 114, a recess is formed between the first frame/contact plate assembly receiving space 186 and the frame 116b since the central rib 222b has a height that is less than the height of the outer perimeter wall 220b. Likewise, when the frame 116a is attached to the lower cover 114 in the second frame/contact plate assembly receiving space 188 of the lower cover 114, a recess is formed between the second frame/contact plate assembly receiving space 188 and the frame 116a since the central rib 222a has a height that is less than the height of the outer perimeter wall 220a. The fastener receiving extensions 198 on the lower cover 114 align and engage with the fastener receiving extensions 235a, 235b on the frames 116a, 116b. Fasteners 240 extend through the aligned fastener receiving extensions 198, 235a, 235b to secure the frames 116a, 116b to the lower cover 114. When the frames 116a, 116b are attached to the lower cover 114, an upper end of each support finger 200 contacts the respective central rib 222a, 222b.

The third contact plate assembly 60b seats within the recess formed between the first frame/contact plate assembly receiving space 186 of the lower cover 114 and the frame 116b. The central rib 222b seats within the channel 93b. The fingers 200 on the lower cover 114 extend through the apertures 82b, 95b and contact the central rib 222b. The spring legs 110b of the contacts 66b, 68b extend through the cutouts 224b, 226b in the frame 116b. The fourth contact plate assembly 60a seats within the recess formed between the second frame/contact plate assembly receiving space 188 of the lower cover 114 and the frame 116a. The central rib 222a seats within the channel 93a. The fingers 200 on the lower cover 114 extend through the apertures 82a, 95a and contact the central rib 222a. The spring legs 110a of the contacts 66a, 68a extend through the cutouts 224a, 226a in the frame 116a. Each recess formed between the lower cover 114 and the respective contact plate assembly 60a, 60b has a height which allows the contact plate assemblies 60a, 60b to move or “float” upwardly and downwardly between the lower cover 114 and the respective frame 116a, 116b, but prevents the contact plate assemblies 60a, 60b from disengaging from contact with the central rib 222a, 222b of the frames 116a, 116b.

When assembled, the contact plate assembly 60a on the upper cover 112 is above the contact plate assembly 60b on the lower cover 114, and the contact plate assembly 60b on the upper cover 112 is above the contact plate assembly 60a on the lower cover 114.

The electronics package 56 is seated within the electronics receiving area formed by the aligned electronics receiving spaces 138, 184. The electronics package 56 includes circuit board(s) 242 and other suitable electronics. The electronics package 56 also includes a first and second jacks 254, 256 which align with the apertures 150, 152 in the upper cover 112. The jacks 254, 256 are in communication with the circuit board(s) 242. Wires (not shown) can be fed from the ceiling and inserted into the jacks 254, 256 to power the circuits on the circuit board(s) 242.

The conductors 248a, 250a, 248b, 250b on the upper pair of contact plate assemblies 60a, 60b electrically couple with the electronics package 56, and the conductors 248a, 250a, 248b, 250b on the lower pair of contact plate assemblies 60a, 60b electrically couple with the electronics package 56.

The mated upper cover 112, frames 116a, 116b and contact plate assemblies 60a, 60b form an upper assembly or one half of a clamshell. The mated lower cover 114, frames 116a, 116b and contact plate assemblies 60a, 60b form a lower assembly or the other half of the clamshell.

When the upper and lower covers 112, 114 are mated together, the posts 208 on the lower cover 114 seat within the pockets 166 and engage with the walls 160, 162, 164 of the upper cover 112. The surfaces 132, 134, 136, 178, 180, 182 of the end walls 124, 126, 170, 172 are spaced apart from each other to form an opening in each end of the connector 24. The openings conform to the shape of the end of the base wall 30 and conductive strips 32, 34, 36, 38 of the rails 26, 28. While the posts 208 are shown and described as being on the lower cover 114 and the pockets 166 formed in the upper cover 112, the posts 208 can be provided on the upper cover 112 and the pockets 166 formed in the lower cover 114. A fastener, such as a screw (which may be a custom formed screw), is mounted in the boss 192 on the lower cover 114 and in the boss 146 in the upper cover 112. The cable grip 120 may be inserted through the passageway 148 and engages with the fastener. The cable grip 120 can be attached to a line (not shown), such as an aircraft cable, to suspend the connector 24 and the rails 26, 28 from a ceiling or other object.

In each leg 300, 302, the poles of the magnets 70a, 72a in the contact plate assembly 60a mounted on the upper cover 112 are the same as the poles of the magnets 70b, 72b in the contact plate assembly 60b mounted on the lower cover 114, such that the magnets 70a, 72a, 70b, 72b repel each other. This causes the contact plate assembly 60a mounted on the upper cover 112 to be moved upwardly relative to the frame 116a and the contact plate assembly 60b mounted on the lower cover 114 to be moved downwardly relative to the frame 116b. In each leg 300, 302, this forms part of the opening into which the respective rail 26, 28 can be inserted into the connector 24.

In use, the rail 26 is slid into the opening in the end of the connector 24 and between the frames 116a, 116b. Since the opening conforms in shape to the end of the rail 26, a secure fit is provided. The end of the rail 26 abuts against the walls 162, 208 of the side walls 128, 130 such that the rail 26 cannot enter into the electronics receiving spaces 164, 184. When the rail 26 is inserted, the contact plate assembly 60a is positioned over the upper surface of the end of the rail 26 such that the contact 66a is above the conductive strip 32 and the contact 68a is above the conductive strip 34, and the contact plate assembly 60b is positioned under the lower surface of the end of the rail 26 such that the contact 66b is below the conductive strip 36 and the contact 68b is below the conductive strip 38.

The rail 26 disrupts the repulsive magnetic force between the magnets 70a, 72a, 70b, 72b and the conductive strips 32, 34, 36, 38 of the rail 26 attract the magnets 70a, 72a, 70a, 72c so that the magnets 70a, 72a, 70a, 72c engage magnetically with the conductive strips 32, 34, 36, 38 of the rail 26 to lock the connector 24 to the rail 26. The contact plate assembly 60a on the upper cover 112 moves within its recess toward the conductive strips 32, 34 of the rail 26 and the spring legs 110a of the contacts 66a, 68a engage with the conductive strips 32, 34 of the rail 26. The spring legs 110a can compress to ensure a proper contact of the contacts 66a, 68a to compress and ensure a secure contact of the contacts 66a, 68a with the conductive strips 32, 34 of the rail 26. The contact plate assembly 60b on the lower cover 114 moves within its recess toward the conductive strips 36, 38 of the rail 26 and the spring legs 110b of the contacts 66b, 68b engage with the conductive strips 36, 38 of the rail 26. The spring legs 110a can compress to ensure a proper contact. The pulling force of the magnets 70a, 72a, 70b, 72b causes the spring legs 110b of the contacts 66b, 68b to compress and ensure a secure contact of the contacts 66b, 68b with the conductive strips 36, 38 of the rail 26. This electrically connects the conductive strips 32, 34, 36, 38 on the rail 26 to the electronics package 56.

In use, the rail 28 is slid into the opening in the other end of the connector 24 and between the frames 116b, 116a. The end of the rail 28 abuts against the walls 164, 206 of the side walls 128, 130 such that the rail 28 cannot enter into the electronics receiving spaces 138, 184. Since the opening conforms in shape to the end the rail 28, a secure fit is provided. When the rail 28 is inserted, the contact plate assembly 60b is positioned over the upper surface of the end of the rail 28 such that the contact 66b is above the conductive strip 32 of rail 28 and the contact 68b is above the conductive strip 34 of rail 28, and the contact plate assembly 60a is positioned under the lower surface of the end of the rail 28 such that the contact 66a is below the conductive strip 36 of rail 28 and the contact 68a is below the conductive strip 38 of rail 28.

The rail 28 disrupts the repulsive magnetic force between the magnets 70b, 72b, 70a, 72a, and the conductive strips 32, 34, 36, 38 of the rail 28 attract the magnets 70b, 72b, 70a, 72a so that the magnets 70b, 72b, 70a, 72a engage magnetically with the conductive strips 32, 34, 36, 38 of the rail 28 to lock the connector 24 to the rail 28. The contact plate assembly 60b moves within its recess toward the conductive strips 32, 34 of the rail 28 and the spring legs 110b of the contacts 66b, 68b engage with the conductive strips 32, 34 of the rail 28. The spring legs 110b can compress to ensure a proper contact. The contact plate assembly 60a moves within its recess toward the conductive strips 36, 38 of the rail 28 and the spring legs 110a of the contacts 66a, 68a engage with the conductive strips 36, 38. The spring legs 110a can compress to ensure a proper contact. The pulling force of the magnets 70b, 72b, 70a, 72a causes the spring legs 110b of the contacts 66a, 68a to compress and ensure a secure contact of the contacts 66a, 68a with the conductive strips 32, 34, 36, 38 of the rail 28. This electrically connects the conductive strips 32, 34, 36, 38 on the rail 28 to the electronics package 56.

A fastener 256, such as a screw, can be inserted through the upper cover 112, through the rail 26 and into the lower cover 114 to further secure the assembly of the connector 24 to the rail 26. Likewise, a fastener 258, such as a screw, can be inserted through the upper cover 112, through the rail 28 and into the lower cover 114 to further secure the assembly of the connector 24 to the rail 28.

Depending upon how the electronics package 56 is configured, the electronics package 56 is used to energize selected ones of the conductive strips 32, 34, 36, 38 on the rails 26, 28. In a first arrangement, connection to the first jack 254 energizes the upper conductive strips 32, 34 on the rails 26, 28, and connection to the second jack 256 energizes the lower conductive strips 36, 38 on the rails 26, 28. In a second arrangement, connection to the first jack 254 energizes the upper and lower conductive strips 32, 34, 36, 38 on the rail 26, and connection to the second jack 256 energizes the upper and lower conductive strips 32, 34, 36, 38 on the rail 28. In a third arrangement, connection to the first jack 254 energizes the upper and lower conductive strips 32, 34, 36, 38 on one of the rails for example rail 26, and connection to the second jack 256 does not energize the upper and lower conductive strips 32, 34, 36, 38 on the other rail for example rail 28. In a fourth arrangement, connection to the first jack 254 energizes the upper conductive strips 32, 34 on one of the rails for example rail 26, connection to the second jack 256 energizes the lower conductive strips 36, 38 on the same rail for example rail 26, and the conductive strips 32, 34, 36, 38 on the other rail for example rail 28 are not energized.

While the frames 116a, 116b are shown as two separate frames, the frames 116a, 116b can be integrally formed as a one-piece member.

While the conductors 248a, 250a, 248b, 250b, are shown as flexible wires, the conductors 248a, 250a, 248b, 250b, may be formed from the same flexible metal as the spring legs 110a.

The bottom profile of the system 20 is aesthetically pleasing. No screw holes are seen from the bottom of the system 20.

While the connector 24 is shown as linear in FIGS. 1-18 from end wall 124 to end wall 126, the electronics receiving space 138 of the upper cover 112 and the electronics receiving space 184 of the lower cover 114 which form the electronics receiving area can be formed with a right angle as shown in FIG. 19 (or may be formed with any other desired angle) to form an L-shape or a substantially L-shape.

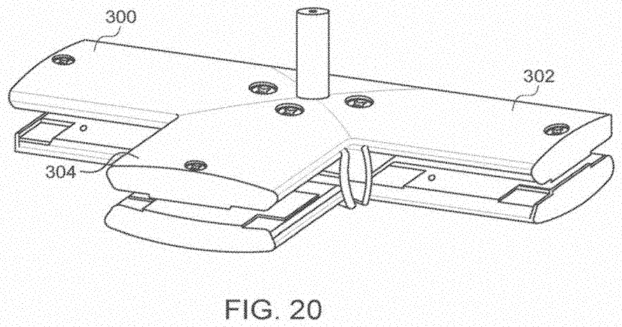

As discussed herein, FIGS. 1-19 show the connector 24 with two legs 300, 302 with the electronics receiving area formed by the electronics receiving space 138 of the upper cover 112 and the electronics receiving space 184 of lower cover 114 between the legs 300, 302. As shown in FIG. 20, the upper cover 112 and the lower cover 114 can be modified to form a T-shape such that a third leg 304 is formed. The third leg 304 includes an upper frame, such as frame 116a, attached thereto and its contact plate assembly, such as contact plate assembly 60a, mounted therebetween, and includes a lower frame, such as lower frame 116a, attached thereto and its contact plate assembly 60a mounted thereto. The contact plate assemblies in the third leg 304 are in electrical communication with the electronics package 56 mounted in the electronics receiving area. Power can be supplied from one leg, for example leg 300, to one or both of the other legs 302, 304.

As shown in FIG. 21, the upper cover 112 and the lower cover 114 can be modified to form a X-shape such that a third leg 304 and a fourth leg 306 are formed. Each of the third and fourth legs 304, 306 includes an upper frame, such as frame 116a, attached thereto and its contact plate assembly, such as contact plate assembly 60a, mounted therebetween, and includes a lower frame, such as lower frame 116b, attached thereto and its contact plate assembly 60a mounted thereto. The contact plate assemblies in the third and fourth legs 304 are in electrical communication with the electronics package 56 mounted in the electronics receiving area. Power can be supplied from one leg, for example leg 300, to one, two and/or three of the other legs 302, 304, 306.

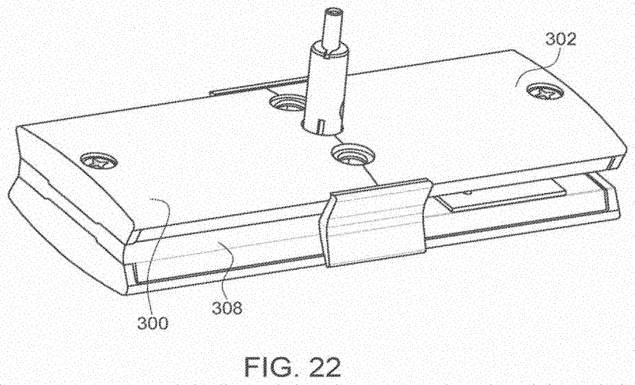

As shown in FIG. 22, one leg, for example leg 300, of the connector 24 can be capped with a cap 308. The cap 308 replaces the frames 116a, 116 and the contact plate assemblies 60a, 60b such that no electrical connection is provided to that leg of the connector 24. Attention is invited to the second embodiment of the system 1020 which includes the lights 22, the connector 1024 and the rails 1026, 1028 shown in FIGS. 3A, 3B, 4A, 4B, 12-14 and 23-28. In addition, the system 1020 includes a driver (not shown) which is connected to a power source and is used to energize the conductive strips 1032, 1034 of the rails 1026, 1028.

The connector 1024 includes the cover 1112, the frame 1116 attached to the cover 1112, and a pair of the contact plate assemblies 60a, 60b mounted between the cover 1112 and the frame 1116. The contact plate assemblies 60a, 60b have been described herein and the specifics are not repeated. The connector 1024 seats onto the end portions of the adjacent rails 1026, 1028.

The cover 1112 is formed from a base wall 1122, a first end wall 1124 extending downwardly from a first end of the base wall 1122, and a second end wall 1126 extending downwardly from a second end of the base wall 1122. The base wall 1122 may be curved.

The end walls 1124, 1126 have a lower edge which has a central portion 1132 and side portions 1134, 1136 that extend outwardly from the central portion 1132. The central portion 1132 is offset downwardly from the side portions 1134, 1136.

The lower surface of the base wall 1122 defines a central space 1138, a first frame/contact plate assembly receiving space 1140 between the central space 1138 and the first end of the base wall 1122, and a second frame/contact plate assembly receiving space 1142 between the central space 1138 and the second end of the base wall 1122. A plurality of support ribs 1144 extend downwardly from the lower surface. A boss 1146 extends downwardly from the lower surface of the central space 1138. The boss 1146 includes a passageway 1148 therethrough.

A plurality of fastener receiving extensions 1154 extend downwardly from the lower surface of the spaces 1138, 1140, 1142. Each fastener receiving extension 1154 has a fastener receiving bore 1156 therein. A plurality of spaced apart support fingers 1158 also extend downwardly from the lower surface of the first and second frame/contact plate assembly receiving spaces 1140, 1142. The support fingers 1158 are linearly aligned with each other and fall along the centerline of the cover 1112.

The frame 1116 is formed from an outer perimeter wall 1220, a first central rib 1222a, a second central rib 1222b, and a cross rib 1223 which form two pairs of cutouts 1224a, 1226a, 1224b, 1226b. The frame 1116 is formed of plastic. The outer perimeter wall 1220 is formed of a first section 1228, a second section 1230 which is perpendicular to the first section 1228, a third section 1232 which is perpendicular to the second section 1230 and parallel to the first section 1228, and a fourth section 1234 which is perpendicular to the third section 1232 and parallel to the second section 1230. The sections 1228, 1230, 1232, 1234 of the outer perimeter wall 1220 define a plane along their first surfaces. The cross rib 1223 extends between the first and third sections 1230, 1234. The central rib 1222a extends between the first section 1228 and the cross rib 1223. The sections 1228, 1232 have a lower edge which matches the profile of the lower edge of the end walls 1124, 1126 of the upper cover 1112. The central rib 1222b extends between the third section 1232 and the cross rib 1223.

The frame 1116 has a plurality of fastener receiving extensions 1235 therethrough which receive fasteners 1238 in passageways 1236 therethrough for attaching the frame 1116 to the cover 1112. In an embodiment, the fastener receiving extensions 1235 extend from the first and third sections 1228, 1232.

The second and fourth sections 1230, 1234 of the outer perimeter wall 1220 have outer surfaces which match the profile of the side walls 1048a, 1048b of the rails 1026, 1028. As shown, the outer surfaces of the second and fourth sections 1230, 1234 are angled outwardly.

When the frame 1116 is attached to the cover 1112, the section 1228 abuts against the inside end wall 1124, the section 1232 abuts against the end wall 1126, and the upper edges of the sections 1230, 1234 abut against the base wall 1122, such that a recess is formed between the first frame/contact plate assembly receiving space 1140 and the frame 1116 since the central rib 1222a has a height that is less than the height of the outer perimeter wall 1220, and such that a recess is formed between the second frame/contact plate assembly receiving space 1142 and the frame 1116 since the central rib 1222b has a height that is less than the height of the outer perimeter wall 1220. The cross rib 1223 is within the central space 1138 and the boss 1148 seats within a bore in the cross rib 1223. The fastener receiving extensions 1154 on the cover 1112 align and engage with the fastener receiving extensions 1235 on the frame 1116. Fasteners 1238 extend through the aligned fastener receiving extensions 1154, 1235 to secure the frame 1116 to the cover 1112. When the frame 1116 is attached to the cover 1112, a lower end of each support finger 1158 engages the respective central ribs 1222a, 1222b.

The first contact plate assembly 60a seats within the recess formed between the first frame/contact plate assembly receiving space 1140 and the frame 1116. The central rib 1222a seats within the channel 93a. The fingers 1158 on the cover 1112 extend through the apertures 82a, 95a and contact the central ribs 1222a, 1222b. The spring legs 110a of the contacts 66a, 68a extend through the cutouts 1224, 1226 in the frame 1116. The second contact plate assembly 60b seats within the recess formed between the second frame/contact plate assembly receiving space 1142 and the frame 1116. The central rib 1222b seats within the channel 93b. The fingers 1158 on the cover 1112 extend through the apertures 182b, 195b and contact the central rib 1222b. The spring legs 110b of the contacts 66b, 68b extend through the cutouts 1224b, 1226b in the frame 1116. Each recess formed between the cover 1112 and the respective contact plate assembly 60a, 60b has a height which allows the contact plate assemblies 60a, 60b to move or “float” upwardly and downwardly between the cover 1112 and the frame 1116, but prevents the contact plate assemblies 60a, 60b from disengaging from contact with the central ribs 1222a, 1222b of the frame 1116.

The conductor 248 couples the contacts 66a, 66b together. The conductor 250 couples the contacts 68a, 68b together. The portion of the cover 1112 and the portion of the frame 1116 which forms cutouts 1224a, 1226a form a first leg 400 of the connector 1024, and the portion of the cover 1112 and the portion of the frame 1116 which forms cutouts 1224b, 1226b form a second leg 402 of the connector 1024. The cross rib 1223 and central space 1138 are between the legs 400, 402. In use, the rails 1026, 1028 are abutted end to end and the connector 1024 is seated on the upper surfaces of ends of the rails 1026, 1028. Since the bottom profile of the walls 1132, 1134, 1136 conform in shape to the rails 1026, 1028, a secure fit is provided. The contact plate assembly 60a is positioned over the upper surface of the end of the rail 1026 such that the contact 66a is above the conductive strip 1032 and the contact 68a is above the conductive strip 1034 of rail 1026. The conductive strips 1032, 1034 of the rail 1026 attract the magnets 70a, 72a so that the magnets 70a, 72a engage magnetically with the conductive strips 1032, 1034 of the rail 1026 to lock the connector 1024 to the rail 1026. The contact plate assembly 60a moves within its recess toward the conductive strips 1032, 1034 of the rail 1026 and the spring legs 110a of the contacts 66a, 68a engage with the conductive strips 1032, 1034 of the rail 1026. The spring legs 110a can compress to ensure a proper contact of the contacts 66a, 68a with the conductive strips 1032, 1034 of the rail 1026, 1028. The contact plate assembly 60b is positioned over the upper surface of the end of the rail 1028 such that the contact 66b is above the conductive strip 1032 and the contact 68b is above the conductive strip 1034 of rail 1028. The conductive strips 1032, 1034 of the rail 1028 attract the magnets 70b, 72b so that the magnets 70b, 72b engage magnetically with the conductive strips 1032, 1034 of the rail 1028 to lock the connector 1024 to the rail 1028. The contact plate assembly 60b moves within its recess toward the conductive strips 1032, 1034 of the rail 1028 and the spring legs 110b of the contacts 66b, 68b engage with the conductive strips 1032, 1034 of the rail 1028. The spring legs 110b can compress to ensure a proper contact of the contacts 66b, 68b with the conductive strips 1032, 1034 of the rail 1028.

While the contact plate assemblies 60a, 60b are described as being moveable relative to the frame 1116 and the cover 1112, the contact plate assemblies 60a, 60b may also be stationary relative to the frame 1116 and the cover 1112.

The frame 1116 has at least one depressible button 1260 formed in the second section 1230 and in the fourth section 1234. When the connector 1024 is mated with the rails 1026, 1028, the button 1260 flex and engage with the apertures 1029 in the rails 1026, 1028 to provide a snap-fit lock to further secure the assembly of the connector 1024 to the rails 1026, 1028.

While the frame 1116 is shown as a single frame, two separate frames can be provided.

While the conductors 248, 250 are shown as separate wires, the contacts 66a, 66b and conductor 248 can be integrally formed, and the contacts 68a, 68b and conductor 250 can be integrally formed.

The driver is attached to one of the rails (e.g., via a connector), for example the rail 1026, for providing power to the system 1020. The driver is connected to a power source. The driver may have an on/off button for activating the driver. The connector may additionally or alternatively have a button.

The bottom profile of the system 20 is aesthetically pleasing. No screw holes are seen from the bottom of the system 20.

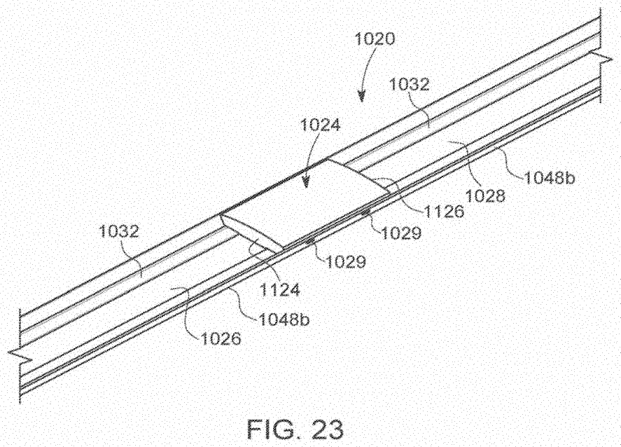

While the connector 1024 is shown as linear in FIGS. 23-28 from end wall 1124 to end wall 1126, the cross rib 1223 and central space 1138 can be formed with a right angle as shown in FIG. 29 (or may be formed with any other desired angle) to form an L-shape or a substantially L-shape.

As discussed herein, FIGS. 23-28 show the connector 1024 with two legs 400, 402 with the cross rib 1223 and central space 1138 between the legs 400, 402. As shown in FIG. 30, the cover 1112 and the frame 1116 can be modified to form a L-shape such that a third leg 404 is formed. The third leg 404 includes a contact plate assembly, such as contact plate assembly 60a, mounted between the frame 1116 and the cover 1112. The contact plate assembly in the third leg 404 is in electrical communication with the contact plate assemblies 60a, 60b mounted in the first and second legs 400, 402. Power can be supplied from one leg, for example leg 400, to one or both of the other legs 402, 404.

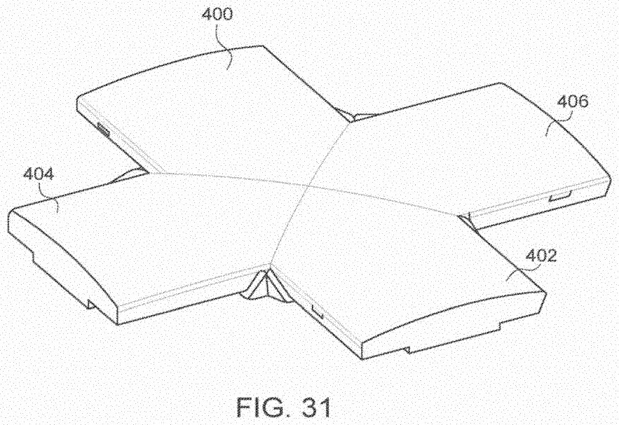

As shown in FIG. 31, the upper cover 1112 and the frame 1116 can be modified to form a X-shape such that a third leg 404 and a fourth leg 406 are formed. Each of the third and fourth legs 404, 406 includes a contact plate assembly, such as contact plate assembly 60a, 60b mounted between the frame 1116 and the cover 1112. The contact plate assembly in the third and fourth legs 404, 406 are in electrical communication with the contact plate assemblies 60a, 60b mounted in the first and second legs 400, 402. Power can be supplied from one leg, for example leg 400, to one, two and/or three of the other legs 402, 404, 406.

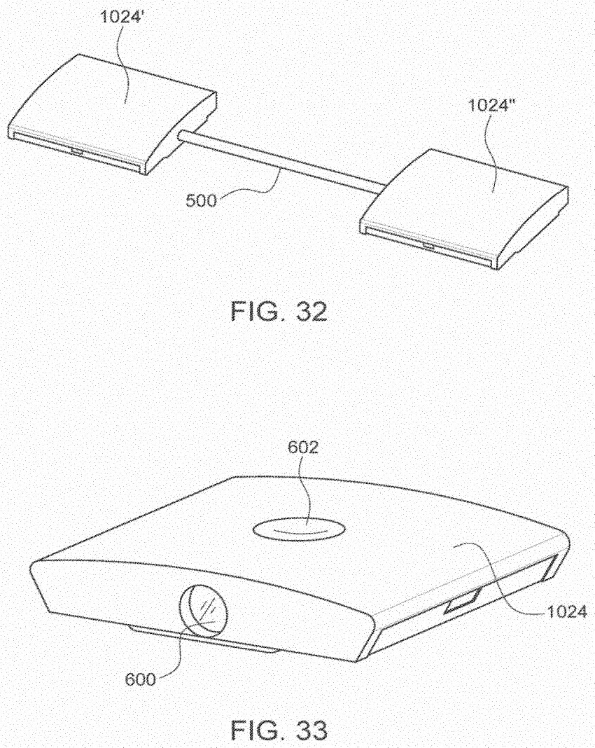

As shown in FIG. 32, the first leg 400 and the second leg 402 can be separated from each other to form two separate connectors 1024′ and 1024″. To affect this, the cover 1112 is split in half and the cross rib 1223 of the frame 1116 is split in half to form the two separate connectors 1024′ and 1024″. Conductors 248, 250 are replaced with a flexible wire 500 to connect the contact plate assemblies 60a, 60b together. This wire 500 allows one connector 1024′ to be mounted on one side of an obstacle in the cabinet construction and the other connector 1024″ to be mounted on the other side of the obstacle.

FIG. 33 shows a modified connector 1024 which has been modified to include a barrel jack 600 and a power button 602 (the modified connector is also a shorter version of connector 1024). The barrel jack 600 provides for power to the connector 1024. The button is electrically connected to the barrel jack 600 to enable power to flow through the connector 1024 when the power button 602 is switched on, and to prevent power flow through the connector 1024 when the power button 602 is switched off. In this embodiment, the magnets 70a, 72a, 70b, 72b are eliminated and the connector 1024 is attached to the rail 1026 or 1028 by clips (or snaps).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system to which a light or lights can be mounted in an under cabinet or suspended configuration, comprising:
a first rail including a base wall having an upper surface and a lower surface, first and second conductive strips mounted on the upper surface, and third and fourth conductive strips mounted on the lower surface;
a second rail including a base wall having an upper surface and a lower surface, first and second conductive strips mounted on the upper surface, and third and fourth conductive strips mounted on the lower surface;
a connector configured to connect the first rail to the second rail, the connector including
a first housing, a first conductive contact mounted in the first housing and configured for electrical connection to the first conductive strip on the first rail, a second conductive contact mounted in the first housing and configured for electrical connection to the second conductive strip on the first rail, a magnet mounted in the first housing, the magnet being spaced from the first and second contacts,
a second housing, a first conductive contact mounted in the second housing and configured for electrical connection to the first conductive strip on the second rail, a second conductive contact mounted in the second housing and configured for electrical connection to the second conductive strip on the second rail, a magnet mounted in the second housing, the magnet mounted in the second housing being spaced from the first and second contacts mounted on the second housing,
an upper cover,
at least one upper frame attached to the upper cover, the first and second housings being mounted between the upper cover and the at least one upper frame,
a third housing, a first conductive contact mounted in the third housing and configured for electrical connection to the third conductive strip on the first rail, a second conductive contact mounted in the third housing and configured for electrical connection to the fourth conductive strip on the first rail, a magnet mounted in the third housing, the magnet mounted in the third housing being spaced from the first and second contacts mounted on the third housing;
a fourth housing, a first conductive contact mounted in the fourth housing and configured for electrical connection to the third conductive strip on the first rail, a second conductive contact mounted in the fourth housing and configured for electrical connection to the fourth conductive strip on the first rail, a magnet mounted in the fourth housing, the magnet mounted in the fourth housing being spaced from the first and second contacts mounted on the fourth housing,
a lower cover coupled to the upper cover,
at least one lower frame attached to the lower cover, the third and fourth housings being mounted between the lower cover and the at least one lower frame,
at least one circuit board mounted on one of the covers,
wherein each first conductive contact and each second conductive contact is attached to the circuit board; and
wherein the magnets mounted in the first and third housings are magnetically attracted to the first rail, and the magnets mounted in the second and fourth housings are magnetically attracted to the second rail, and wherein the magnet in the first housing has a pole facing the magnet in the third housing, and the poles in the first and third housings are opposite, and wherein the magnet in the second housing has a pole facing the magnet in the fourth housing, and the poles in the second and fourth housings are opposite.

2. The system of claim 1, wherein the at least one circuit board is mounted on the lower cover.

3. The system of claim 1, wherein each conductive contact is electrically coupled to the at least one circuit board by a wire.

4. The system of claim 1, wherein each rail further includes at least one side wall extending from the base wall.

5. The system of claim 1, wherein each rail further includes a pair of side walls extending from the base wall.

6. The system of claim 1, wherein two magnets are provided in each housing.

7. The system of claim 1, wherein at least one of the rails has a first portion which is linear, and a second portion which is angled relative to the first portion.

8. The system of claim 1, wherein the rails are formed of aluminum and the conductive strips are formed of steel with a nickel plate and an overplate stripe of palladium.

9. The system of claim 1, wherein each contact has a spring leg which flexes when engaged with the respective conductive strip on the rail.

10. The system of claim 1, wherein each housing is moveable relative to its respective frame and cover.

11. The system of claim 1, further in combination with at least one light mounted on the first rail, and at least one light mounted on the second rail.

12. The system of claim 1, further comprising a cable grip connected to the upper cover.

13. The system of claim 1, wherein one of the covers has a plurality of posts and the other cover has a plurality of pockets into which the posts engage to mate the upper and lower covers together.

14. The system of claim 1, wherein the upper and lower covers have a plurality of support ribs thereon.

15. The system of claim 1, wherein
the upper cover includes a plurality of fingers extending downwardly therefrom, the first and second housings have a plurality of apertures therethrough, wherein the fingers extend through the apertures such that the fingers contact the at least one upper frame, and
the lower cover includes a plurality of fingers extending upwardly therefrom, the third and fourth housings have a plurality of apertures therethrough, wherein the fingers extending from the lower cover extend through the apertures through the third and fourth housings such that the fingers extending from the lower cover contact the at least one lower frame.

16. A system to which a light or lights can be mounted in an under cabinet or suspended configuration, comprising:
a first rail including a base wall and first and second conductive strips mounted on an upper surface thereof;
a second rail including a base wall and first and second conductive strips mounted on an upper surface thereof;
a connector configured to connect the first rail to the second rail, the connector including
a first housing, a first conductive contact mounted in the first housing and configured for electrical connection to the first conductive strip on the first rail, a second conductive contact mounted in the first housing and configured for electrical connection to the second conductive strip on the first rail, a magnet mounted in the first housing, the magnet being spaced from the first and second contacts, and
a second housing, a first conductive contact mounted in the second housing and configured for electrical connection to the first conductive strip on the second rail, a second conductive contact mounted in the second housing and configured for electrical connection to the second conductive strip on the second rail, a magnet mounted in the second housing, the magnet mounted in the second housing being spaced from the first and second contacts mounted on the second housing;
wherein the first conductive contact mounted in the first housing is electrically coupled to the first conductive contact mounted in the second housing, and the second conductive contact mounted in the first housing is electrically coupled to the second conductive contact mounted in the second housing; and
wherein the magnet mounted in the first housing is magnetically attracted to the first rail, and the magnet mounted in the second housing is magnetically attracted to the second rail.

17. The system of claim 16, wherein two magnets are provided on each housing.

18. The system of claim 16, wherein the two housings are integrally formed with each other.

19. The system of claim 16, wherein the first conductive contact mounted in the first housing is electrically coupled to the first conductive contact mounted in the second housing by a wire, and the second conductive contact mounted in the first housing is electrically coupled to the second conductive contact mounted in the second housing by a wire.

20. The system of claim 16, wherein the first conductive contact mounted in the first housing is integrally formed with the first conductive contact mounted in the second housing, and the second conductive contact mounted in the first housing is integrally formed with the second conductive contact mounted in the second housing.

21-32. (canceled)
